(19) United States
(12) Patent Application Publication
(10) Pub. No.: US 2026/0148550 A1
(43) Pub. Date: May 28, 2026

(54) DISAMBIGUATION TECHNIQUES FOR REFERENCING OBJECTS WITH A HEAD-WEARABLE DEVICE AND SYSTEMS OF USE THEREOF

(71) Applicant: Meta Platforms Technologies, LLC, Menlo Park, CA (US)

(72) Inventors: Ajoy Savio Fernandes, Seattle, WA (US); Michael John Proulx, II, Redmond, WA (US); Naveen Sendhilnathan, New York, NY (US); Kashyap Todi, Seattle, WA (US)

(21) Appl. No.: 19/402,873

(22) Filed: Nov. 26, 2025

Related U.S. Application Data
(60) Provisional application No. 63/726,132, filed on Nov. 27, 2024.

(51) Int. Cl. G06V 20/20; G06F 3/01; G06F 3/0488; G06V 10/26; G06V 10/94; G06V 20/50; G06V 20/70; H04N 23/61

(52) U.S. Cl. CPC G06V 20/20; G06F 3/013; G06F 3/0488; G06V 10/26; G06V 10/945; G06V 20/50; G06V 20/70; H04N 23/61

(57) ABSTRACT

A method of disambiguating objects identified in image data captured at a head-wearable device is described. The method includes: (i), in response to a capture command performed by the user, capturing image data of a point-of-view of the user at one or more cameras of the head-wearable device, wherein the capture command is directed at target objects within the point-of-view of the user, (ii) identifying objects within the image data, (iii), in accordance with a determination that a confidence score indicating which of the objects are the target objects is below a confidence threshold, presenting representations of the objects to the user at a display device, (iv), in response to a select input directed at the representations of the objects, determining which of the objects are the target objects based on the select input, and (v) performing tasks based on the capture command and the target objects.

### RELATED APPLICATION

This application claims priority to U.S. Provisional Application Ser. No. 63/726,132, filed Nov. 27, 2024, entitled “Apparatus, System, And Method For AI-Assisted Disambiguation Of Object Selection By Users Wearing Head-Mounted Displays,” which is incorporated herein by reference.

### TECHNICAL FIELD

This relates generally to techniques for disambiguating between objects identified by an artificially intelligent (AI) assistant from image data captured at a head-worn device.

### BACKGROUND

The use of head-worn devices with forward-facing cameras as well as the use of artificially intelligent (AI) computer vision techniques allow user devices to identify what a user is looking at. These computer vision techniques can be augmented by gaze tracking techniques which allow the user devices to know where, in the captured image data, the user is looking. However, gaze based targeting techniques have their limitations and often inaccurate, even with AI based assistance. The inaccuracy of gaze based targeting techniques further increases the further the user is from the object they are targeting. A low friction manner, in accurately selecting an object, or part of an object in the field-of-view of the user would assist the gaze based targeting techniques is identifying the object the user is targeting.

As such, there is a need to address one or more of the above-identified challenges. A brief summary of solutions to the issues noted above are described below.

### SUMMARY

One example of a method of disambiguating objects identified in image data captured at a head-wearable device is described herein. This example method occurs at a head-wearable device (e.g., a pair of smart glasses) with one or more cameras and a display device (e.g., a wrist-wearable device (e.g., a smart watch), a smartphone, and/or one or more displays of the head-wearable device) with one or more displays. The method occurs while the head-wearable device is worn by a user and the head-wearable device is communicatively coupled to the display device. In some embodiments, the method includes, in response to a capture command performed by the user, causing one or more cameras of the head-wearable device to capture image data of a point-of-view of the user (e.g., a field-of-view of the user), wherein the capture command is directed at one or more target objects (e.g., a flower vase) within the point-of-view of the user. The method further includes identifying a plurality of objects within the image data. The method further includes, in accordance with a determination that a confidence score indicating which of the plurality of objects is the one or more target objects is below a confidence threshold, causing one or more representations of the plurality of objects (e.g., a textual representation, a visual representation taken from the image data, and/or a generation visual representation) to be presented to the user at the display device. The method further includes, in response to a select input (e.g., one or more touch inputs) directed at the one or more representations of the plurality of objects, determining which of the plurality of objects is the one or more target objects based on the select input. The method further includes causing one or more tasks to be performed based on the capture command and the one or more target objects.

In some embodiments, the capture command is further directed at one or more target segments of a plurality of segments (e.g., a vase, flowers, and flower stems of a flower vase) that comprise the one or more target objects within the image data. Additionally, the method further includes identifying the plurality of segments that comprise the one or more target objects. The method further includes, in accordance with the determination of which of the plurality of objects is the one or more target objects and a determination that another confidence score indicating which of the plurality of segments is the one or more target segments is below another confidence threshold, causing one or more representations of the plurality of segments to be presented to the user at the display device. The method further includes, in response to another select input directed at the one or more representations of the plurality of segments, determining which of the plurality of segments is the one or more target segments based on the other select input. The method further includes, causing one or more other tasks to be performed based on the capture command and the one or more target segments

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A illustrates a head-wearable device, worn by a user, and another device that is communicatively coupled to the head-wearable device, in accordance with some embodiments.

FIG. 1B illustrates a field-of-view of the user, in accordance with some embodiments.

FIGS. 2A-2B illustrate a first wrist disambiguation technique that the user may perform to assist the AI assistant in determining a target object which includes the user performing a disambiguation touch input at the wrist-wearable device in response to a disambiguation user interface (UI) presented at the display of the wrist-wearable device, in accordance with some embodiments.

FIGS. 3A-3E illustrate a second wrist disambiguation technique that the user may perform to assist the AI assistant in determining one or more selected segments of the target object which includes the user performing one or more segmentation touch inputs at the wrist-wearable device in response to a segmentation UI presented at the display of the wrist-wearable device, in accordance with some embodiments.

FIG. 4 illustrates a third wrist disambiguation technique that the user may perform to assist the AI assistant in determining one or more selected segments of the target object which includes the user performing one or more other segmentation touch inputs at the wrist-wearable device in response to another segmentation UI presented at the display of the wrist-wearable device, in accordance with some embodiments.

FIG. 5 illustrates a flow diagram of a method of disambiguating objects identified in image data captured at a head-wearable device, in accordance with some embodiments.

FIGS. 6A, 6B, 6C-1, and 6C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

A gaze gesture, as described herein, can include an eye movement and/or a head movement indicative of a location of a gaze of the user, an implied location of the gaze of the user, and/or an approximated location of the gaze of the user, in the surrounding environment, the virtual environment, and/or the displayed user interface. The gaze gesture can be detected and determined based on (i) eye movements captured by one or more eye-tracking cameras (e.g., one or more cameras positioned to capture image data of one or both eyes of the user) and/or (ii) a combination of a head orientation of the user (e.g., based on head and/or body movements) and image data from a point-of-view camera (e.g., a forward-facing camera of the head-wearable device). The head orientation is determined based on IMU data captured by an IMU sensor of the head-wearable device. In some embodiments, the IMU data indicates a pitch angle (e.g., the user nodding their head up-and-down) and a yaw angle (e.g., the user shaking their head side-to-side). The head-orientation can then be mapped onto the image data captured from the point-of-view camera to determine the gaze gesture. For example, a quadrant of the image data that the user is looking at can be determined based on whether the pitch angle and the yaw angle are negative or positive (e.g., a positive pitch angle and a positive yaw angle indicate that the gaze gesture is directed toward a top-left quadrant of the image data, a negative pitch angle and a negative yaw angle indicate that the gaze gesture is directed toward a bottom-right quadrant of the image data, etc.). In some embodiments, the IMU data and the image data used to determine the gaze are captured at a same time, and/or the IMU data and the image data used to determine the gaze are captured at offset times (e.g., the IMU data is captured at a predetermined time (e.g., 0.01 seconds to 0.5 seconds) after the image data is captured). In some embodiments, the head-wearable device includes a hardware clock to synchronize the capture of the IMU data and the image data. In some embodiments, object segmentation and/or image detection methods are applied to the quadrant of the image data that the user is looking at.

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

Disambiguation Techniques for Referencing Objects with a Head-Wearable Device

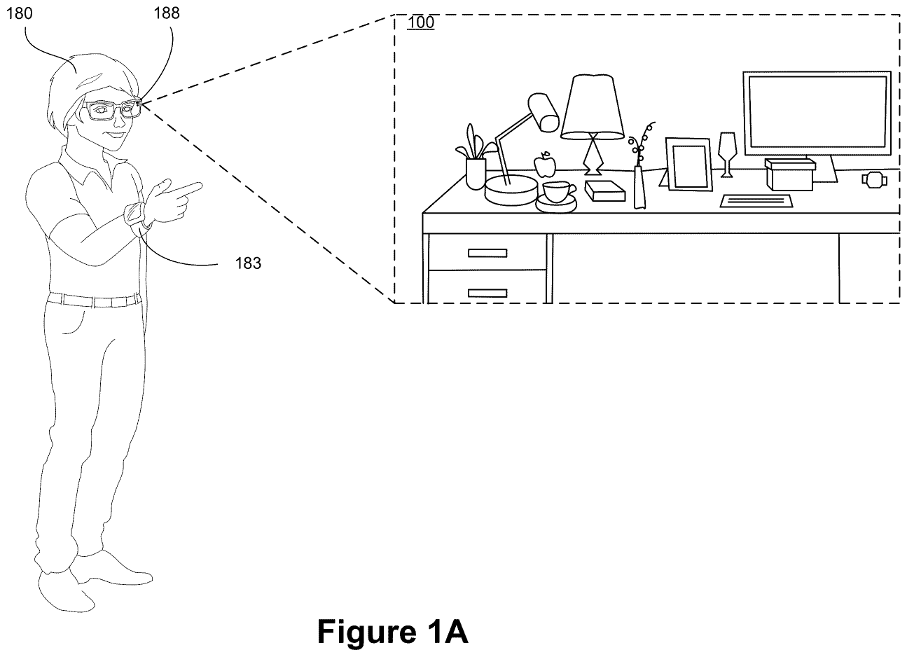

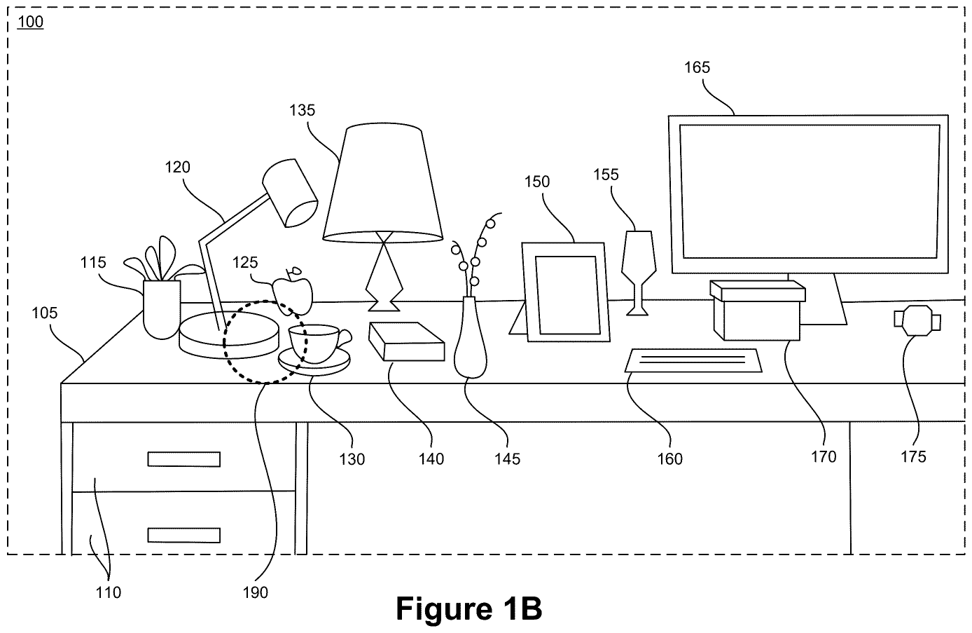

FIG. 1A illustrates a head-wearable device 188, worn by a user 180, and another device that is communicatively coupled to the head-wearable device 188, in accordance with some embodiments. In some embodiments, the forgoing embodiments of disambiguation techniques occur at a system including the head-wearable device 188, worn by the user 180, and the other device. The head-wearable device 188 is one or more of a pair of smart glasses (e.g., displayless smart glasses), an extended-reality (XR) headset (e.g., a virtual-reality (VR) headset, an augmented-reality (AR) headset, etc.), one or more XR contacts, and/or an XR hat. The head-wearable device 188 includes one or more cameras (e.g., one or more forward-facing cameras) for capturing a field-of-view 100 of the user 180 and one or more eye-tracking devices (e.g., one or more eye-tracking cameras and/or a combination of one or more IMUs to determine a head orientation of the user 180 and image data from the one or more cameras) for capturing one or more gaze gestures performed by the user 180. In some embodiments, the head-wearable device 188 further includes one or more microphones for capturing one or more audio inputs from the user 180, one or more speakers for presenting one or more audio outputs to the user 180, and/or one or more displays for presenting one or more visual outputs to the user 180. The other device is one or more of a smartphone, a wrist-wearable device 183 (e.g., a smart watch), one or more displays of the head-wearable device 188, an intermediary processing device, a body-integrated device, and/or a personal computer. The other device includes one or more displays (e.g., one or more touchscreens) for presenting one or more visual outputs to the user 180 and one or more input modalities for receiving inputs from the user 180 (e.g., a touchscreen and/or touchpad for receiving touch inputs from the user 180, one or more motion sensors (e.g., an IMU sensor and/or an EMG sensor) for receiving gesture inputs from the user 180, one or more microphones for receiving voice inputs from the user 180, etc.). In some embodiments, the head-wearable device 188 and/or the other devices are communicatively coupled to one or more processors that are configured to execute one or more tasks for accomplishing steps of the forgoing disambiguation techniques. The one or more processors are located at the head-wearable device 188, the other device, and/or a third device (e.g., a handheld intermediary processing device, a personal computer, a server device, etc.) communicatively coupled to the head-wearable device 188 and/or the other device.

FIG. 1B illustrates a field-of-view 100 of the user 180, in accordance with some embodiments. The field-of-view 100 is captured by the one or more cameras of the head-wearable device 188 while the user 180 is wearing the head-wearable device 188. The field-of-view 100 includes a plurality of objects, including: a desk 105, two desk drawers 110, a potted plant 115, a desk lamp 120, an apple 125, a cup and saucer 130, a shaded lamp 135, a book 140, a flower vase 145, a picture frame 150, a glass 155, a keyboard 160, a monitor 165, a box 170, and a watch 175. FIG. 1B also illustrates a gaze location 190 of the user 180, which is a located within the field-of-view 100 that the user 180 is focusing their gaze at a given moment (e.g., based on gaze data received from the one or more eye-tracking devices). In some embodiments, the AI assistant includes and/or has access to one or more computer vision programs (e.g., an object-recognition machine-learning model) which allow the AI assistant to identify the plurality of objects based on image data of the field-of-view 100. In some embodiments, the user 180 may perform a query input directed at an artificially intelligent (AI) assistant (e.g., executed at the head-wearable device 188, the other device, and/or the third device) that references one or more of the plurality of objects (e.g., the user 180 performs a query voice command “What's this?”, the user 180 performs a query hand gesture (e.g., a double middle-finger pinch gesture), and/or the user 180 performs a query button press (e.g., a button press at a button of the head-wearable device 188 and/or a button press at the other device)). When the plurality of objects is within the field-of-view 100 when the user 180 performs the query input, the AI assistant cannot determine which object of the plurality of objects the user 180 intends to target with the query input (e.g., a target object) based on the image data of the field-of-view 100 alone.

In some embodiments, the AI assistant may be able to determine the target object of the plurality of objects that the user 180 intends to target based on the gaze location 190 within the field-of-view 100. However, in some circumstances, the AI assistant cannot determine which object of the plurality of objects the user 180 intends to target with the query input based on the image data of the field-of-view 100 and the gaze location 190. For example, as illustrated in FIG. 1B, the desk 105, the desk lamp 120, the apple 125, and the cup and saucer 130 are all within the gaze location 190. In some embodiments, if a confidence score associated with any object of the plurality of objects (e.g., a confidence score based on the image data of the field-of-view 100 and the gaze location 190) being the target object exceeds (or is equal to) a confidence score threshold, an object is identified as the target object, and if the confidence score associated with any object of the plurality of objects being the target object is below the confidence score threshold, no object is identified as the target object.

In some embodiments, the AI assistant determines the target object from the plurality of objects (e.g., an object the user 180 intends to target with the query input) based on the image data of the field-of-view 100, the gaze location 190, and one or more probability scores. Each of the one or more probability scores is associated with a respective object within the gaze location 190 (e.g., a desk probability score associated with the desk 105, a desk lamp probability score associated with the desk lamp 120, an apple probability score associated with the apple 125, and a cup probability score associated with the cup and saucer 130). Each of the one or more probability scores is representative of a likelihood that the respective object is the object the user 180 intends to target. In some embodiments, the one or more probability scores is based on the query input. For example, if the query input is a voice command “Where can I buy that lamp?” the one or more probability scores may be a desk probability score of two percent, a desk lamp probability score of ninety-five percent, an apple probability score of one percent, and a cup probability score of one percent. In some embodiments, the one or more probability scores is based on prior behavior of the user 180. For example, if the user 180 was recently looking at different varieties of apples, the one or more probability scores may be a desk probability score of two percent, a desk lamp probability score of four percent, an apple probability score of ninety-three percent, and a cup probability score of one percent. However, in some circumstances, the AI assistant cannot determine which object of the plurality of objects the user 180 intends to target with the query input based on the image data of the field-of-view 100, the gaze location 190, and the one or more probability scores. For example, if the query input is a voice command “What is that red thing?” the one or more probability scores may be a desk probability score of thirty-nine percent, a desk lamp probability score of twenty-five percent, an apple probability score of thirty-five percent, and a cup probability score of one percent.

Other factors may contribute to making it more difficult for the AI assistant (and/or any other program or application that identifies object within the field-of-view 100) to identify the target object from among the plurality of objects. Object position may decrease the likelihood that the AI assistant correctly identifies the target object from among the plurality of objects. For example, the target object (e.g., the desk 105) may be obstructed (partially or entirely) by one or more objects of the plurality of objects and, thus, be less likely to be identified as the target object. Object size may decrease the likelihood that the AI assistant correctly identifies the target object from among the plurality of objects. For example, smaller objects (e.g., the watch 175) may be less likely than larger objects (e.g., the monitor 165) to be identified as the target object. Additionally, apparent object size may decrease the likelihood that the AI assistant correctly identifies the target object from among the plurality of objects. For example, if the user 180 is closer to the target object, it will appear as larger and, thus, it is more likely to be correctly identified as the target object. Object shape may decrease the likelihood that the AI assistant correctly identifies the target object from among the plurality of objects. For example, objects with less distinct shapes (e.g., the book 140) may be less likely than objects with more distinct shapes (e.g., the shaded lamp 135) to be identified as the target object. Object color may decrease the likelihood that the AI assistant correctly identifies the target object from among the plurality of objects. For example, objects that blend in with their background (e.g., the keyboard 160) may be less likely than objects that stand out from their background (e.g., the apple 125) to be identified as the target object.

In some embodiments, the AI assistant (and/or any other program or application that identifies object within the field-of-view 100) is able to identify groups of objects within the plurality of objects and segments of objects of the plurality of objects. For example, in response to a query voice command “Turn my desk lights on,” the AI assistant is able to determine that the target object includes the desk lamp 120 and the shaded lamp 135. As another example, in response to a query voice command “What kind of plant is in the pot?” the AI assistant is able to identify a plant segment and a pot segment of the potted plant 115.

In response to a determination that the AI assistant (and/or any other program or application that identifies object within the field-of-view 100) cannot determine which object of the plurality of objects the user 180 intends to target with the query input based on the image data of the field-of-view 100, the gaze location 190, and/or the one or more probability scores, the head-wearable device 188 and/or the other device presents a disambiguation cue to the user 180. The disambiguation cue indicates, to the user 180, that the user 180 should perform one or more disambiguation techniques to assist the AI assistant in determining the target object. In some embodiments, the disambiguation cue is an audio message (e.g., “Which object are talking about?”) presented at one or more speakers of the head-wearable device 188 and/or the other device, an audio cue (e.g., a beep sound) presented at one or more speakers of the head-wearable device 188 and/or the other device, a haptic cue (e.g., a vibration) presented at one or more haptic devices of the head-wearable device 188 and/or the other device, a light cue (e.g., a light flash) presented at one or more lights of the head-wearable device 188 and/or the other device, and/or a visual prompt (e.g., a visual notification “Which object are you referencing?”) presented at one or more displays of the other device.

A first disambiguation technique that the user 180 may perform to assist the AI assistant in determining the target object is the user 180 moving closer to the target object. For example, the user 180 may perform a first query input (e.g., a double index-finger pinch gesture) while targeting the cup and saucer 130 (e.g., by gazing at the cup and saucer 130). However, the AI assistant (and/or any other program or application that identifies object within the field-of-view 100) cannot determine which object of the plurality of objects is the target object based on the first query input, the image data of the field-of-view 100, and/or the gaze location 190 since the first query input does not identify the target object and there are more than one of the plurality of objects (e.g., the desk lamp 120, the apple 125, and the cup and saucer 130) within the gaze location 190. The user 180 can move closer to the cup and saucer 130 such that the cup and saucer 130 appears larger within the field-of-view 100 of the user 180. Thus, when the user 180 continues to gaze at the cup and saucer 130, it is the only object of the plurality of objects within the gaze location, and the AI assistant can determine that the cup and saucer 130 is the target object. In some embodiments, in response to the AI assistant determining the target object from the plurality of objects after the user 180 moves closer to the target object, a confirmation cue (e.g., a visual confirmation cue, an audio confirmation cue, a light confirmation cue, and/or a haptic confirmation cue) is presented to the user 180 at the head-wearable device 188 and/or the other device.

A second disambiguation technique that the user 180 may perform to assist the AI assistant in determining the target object is the user 180 touching the target object. For example, the user 180 may perform a second query input (e.g., a double index-finger pinch gesture) while targeting the apple 125 (e.g., by gazing at the apple 125) and the AI assistant cannot determine which object of the plurality of objects is the target object based on the second query input, the image data of the field-of-view 100, and/or the gaze location 190 since the second query input does not identify the target object and there are more than one of the plurality of objects within the gaze location 190. The user 180 can touch the apple 125, wherein the image data of the field-of-view 100 captures a finger of the user 180 touching the apple 125, and the AI assistant can determine that the apple 125 is the target object based on the image data. In some embodiments, in response to the AI assistant determining the target object from the plurality of objects after the user 180 touches the target object, the confirmation cue is presented to the user 180 at the head-wearable device 188 and/or the other device.

A third disambiguation technique that the user 180 may perform to assist the AI assistant in determining the target object is the user 180 performing a vocal disambiguation command. For example, the user 180 may perform a third query input (e.g., a double index-finger pinch gesture) while targeting the desk lamp 120 (e.g., by gazing at the desk lamp 120) and the AI assistant cannot determine which object of the plurality of objects is the target object based on the third query input, the image data of the field-of-view 100, and/or the gaze location 190 since the third query input does not identify the target object and there are more than one of the plurality of objects within the gaze location 190. The user 180 can perform a vocal disambiguation command (e.g., “Tell me about the desk lamp”) that identifies the target object from among the plurality of objects, and the AI assistant can determine that the desk lamp 120 is the target object based on the vocal disambiguation command. In some embodiments, in response to the AI assistant determining the target object from the plurality of objects after the user 180 performs the vocal disambiguation command, the confirmation cue is presented to the user 180 at the head-wearable device 188 and/or the other device.

A fourth disambiguation technique that the user 180 may perform to assist the AI assistant in determining the target object is the user 180 performing a directional gesture. For example, the user 180 may perform a fourth query input (e.g., a double index-finger pinch gesture) while targeting the picture frame 150 (e.g., by gazing at the picture frame 150) and the AI assistant cannot determine which object of the plurality of objects is the target object based on the fourth query input, the image data of the field-of-view 100, and/or the gaze location 190 since the fourth query input does not identify the target object and there are more than one of the plurality of objects within the gaze location 190 (e.g., the picture frame 150 and the glass 155 are both within the gaze location 190). The user 180 can perform a directional gesture (e.g., the user 180 moves their hand and/or wrist in a leftward direction to indicate that the picture frame 150 is the target object or in a rightward direction to indicate that the glass 155 is the target object) that identifies the target object, and the AI assistant can determine that the picture frame 150 is the target object based on the directional gesture. In some embodiments, in response to the AI assistant determining the target object from the plurality of objects after the user 180 performs the directional gesture, the confirmation cue is presented to the user 180 at the head-wearable device 188 and/or the other device.

A fifth disambiguation technique that the user 180 may perform to assist the AI assistant in determining the target object is the user 180 performing a confirmation command in response to an audio disambiguation message. For example, the user 180 may perform a fifth query input (e.g., a double index-finger pinch gesture) while targeting the glass 155 (e.g., by gazing at the glass 155) and the AI assistant cannot determine which object of the plurality of objects is the target object based on the fifth query input, the image data of the field-of-view 100, and/or the gaze location 190 since the fifth query input does not identify the target object and there are more than one of the plurality of objects within the gaze location 190 (e.g., the picture frame 150 and the glass 155 are both within the gaze location 190). The head-wearable device 188 and/or the other device then provide two or more audio disambiguation messages (one for each possible object that the AI assistant determines could be the target object) based on the fifth query input, the image data of the field-of-view 100, and/or the gaze location 190. For example, head-wearable device 188 and/or the other device presents a first audio disambiguation message (e.g., “Are you referencing the picture frame?”) followed by the second audio disambiguation message (e.g., “Are you referencing the glass?”). The user 180 can perform the confirmation command (e.g., the user 180 performs a confirmation voice command “Yes” and/or the user 180 performs a confirmation hand gesture (e.g., a single index-finger pinch gesture)) while the second audio disambiguation message is being presented (and not while the first audio disambiguation message is being presented), and the AI assistant can determine that the glass 155 is the target object based on the confirmation command. In some embodiments, in response to the AI assistant determining the target object from the plurality of objects after the user 180 performs the confirmation command, the confirmation cue is presented to the user 180 at the head-wearable device 188 and/or the other device.

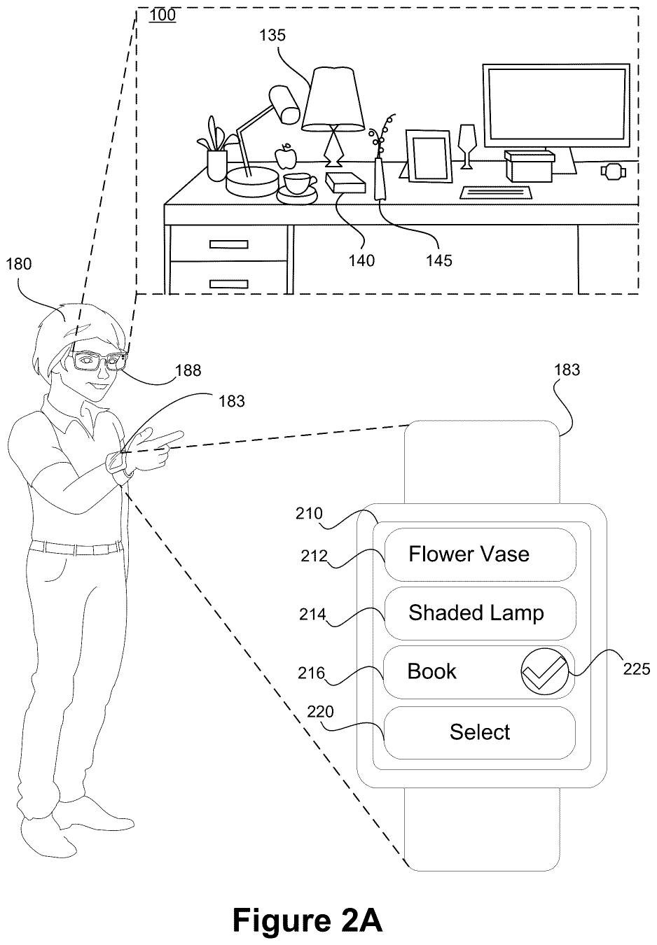

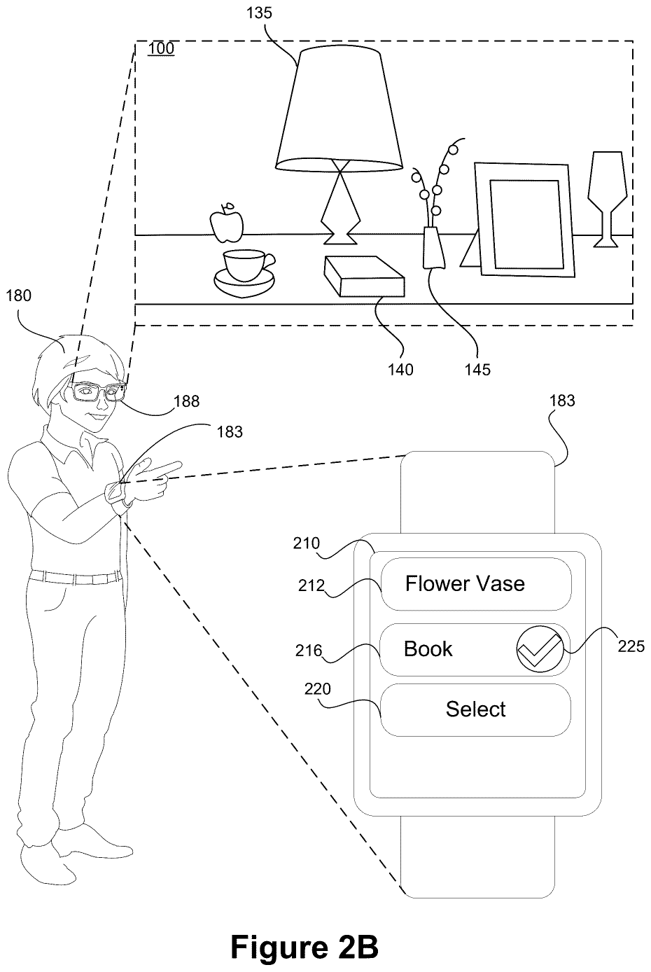

FIGS. 2A-2B illustrate a first wrist disambiguation technique that the user 180 may perform to assist the AI assistant in determining the target object which includes the user 180 performing a disambiguation touch input at the wrist-wearable device 183 in response to a disambiguation user interface (UI) 210 presented at the display of the wrist-wearable device 183, in accordance with some embodiments. While FIGS. 2A-2B illustrate the disambiguation UI 210 presented at the display of the wrist-wearable device 183 and the user 180 performed the disambiguation touch input at the wrist-wearable device 183, the first wrist technique may be performed at another device with at least one display (e.g., a smartphone). FIG. 2A illustrates the wrist-wearable device 183 presenting the disambiguation UI 210 based on the one or more objects in the field-of-view 100, in accordance with some embodiments. In some embodiments, the disambiguation UI 210 includes one or more object UI elements (e.g., a flower vase UI element 212, a shaded lamp UI element 214, and a book UI element 216, as illustrated in FIG. 2A), and each of the one or more object UI elements associated with respective object of the one or more objects (e.g., flower vase 145, the shaded lamp 135, and the book 140). For example, the user 180 may perform a first wrist query input (e.g., a double index-finger pinch gesture) while targeting the book 140 (e.g., by gazing at the book 140) and the AI assistant cannot determine which object of the plurality of objects is the target object based on the first wrist query input, the image data of the field-of-view 100, and/or the gaze location 190 since the first wrist query input does not identify the target object and there are more than one of the plurality of objects within the gaze location 190. In response, the wrist-wearable device 183 displays the disambiguation UI 210 with respective object UI elements associated with each object within the gaze location 190.

In some embodiments, the user 180 may perform the disambiguation touch input (e.g., a touch input at the display of the wrist-wearable device 183) at a target UI element (e.g., the book UI element 216) associated with the target object, and the AI assistant can determine that the book 140 is the target object based on the disambiguation touch input. In some embodiments, the disambiguation UI 210 further includes a selection confirmation UI element 220. In some embodiments, the user 180 may perform one or more disambiguation touch inputs (e.g., one or more touch inputs at the display of the wrist-wearable device 183) at one or more target UI elements (e.g., a flower vase UI element 212, a shaded lamp UI element 214, and a book UI element 216) to select one or more target objects. In some embodiments, a respective selection UI indicator 225 appears next to a respective object UI element in response to the user 180 selecting the respective object UI element (and/or the respective object UI element). The user 180 can then perform another touch input directed at the selection confirmation UI element 220, and the AI assistant can determine the one or more target objects based on which of the one or more object UI elements were selected by the user 180 when the other touch input was performed.

FIG. 2B illustrates the wrist-wearable device 183 presenting the disambiguation UI 210 based on the one or more objects in the field-of-view 100 after the user 180 moves closer to the target object, in accordance with some embodiments. In some embodiments, the user 180 may move closer to the target object (e.g., as described in reference to the first disambiguation technique) to assist the AI assistant in refining the disambiguation UI 210 with the respective object UI elements associated with each object within the gaze location 190. In response to the user 180 moving closer to the target object, the AI assistant (and/or any other program or application that identifies object within the field-of-view 100) updates the object UI elements based on the image data of the field-of-view 100 and/or the gaze location 190. For example, if the user 180 moves closer to the target object (e.g., the book 140), a number of objects within and/or near the gaze location 190 decreases (e.g., the shaded lamp 135 is longer close enough to the gaze location 190 for the AI assistant to consider it to be the target object), and the disambiguation UI 210 is updated to include each of the one or more object UI elements (e.g., the flower vase UI element 212 and the book UI element 216, as illustrated in FIG. 2B) associated with a remainder of the one or more object UI elements.

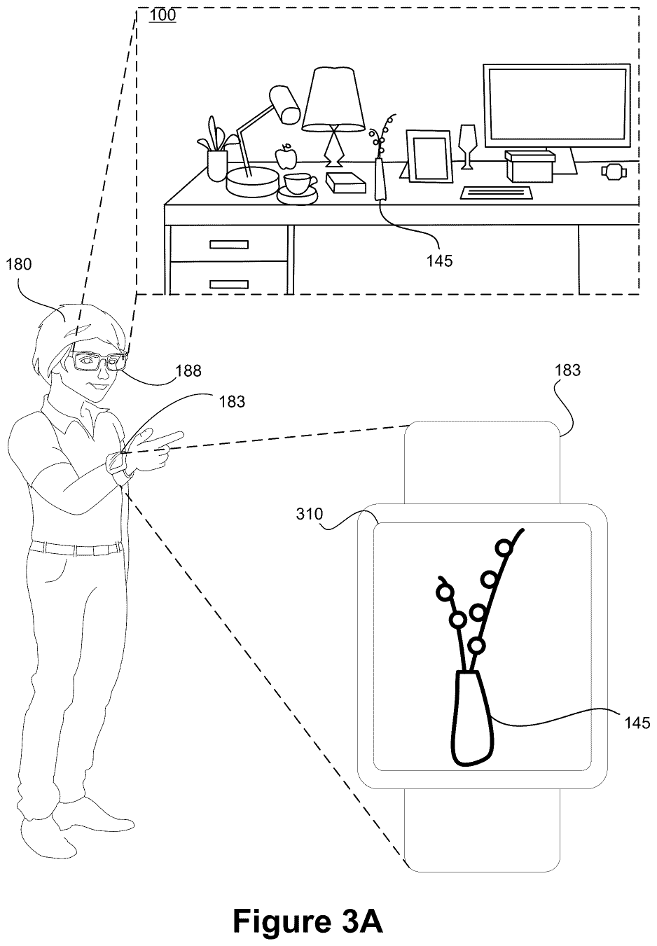

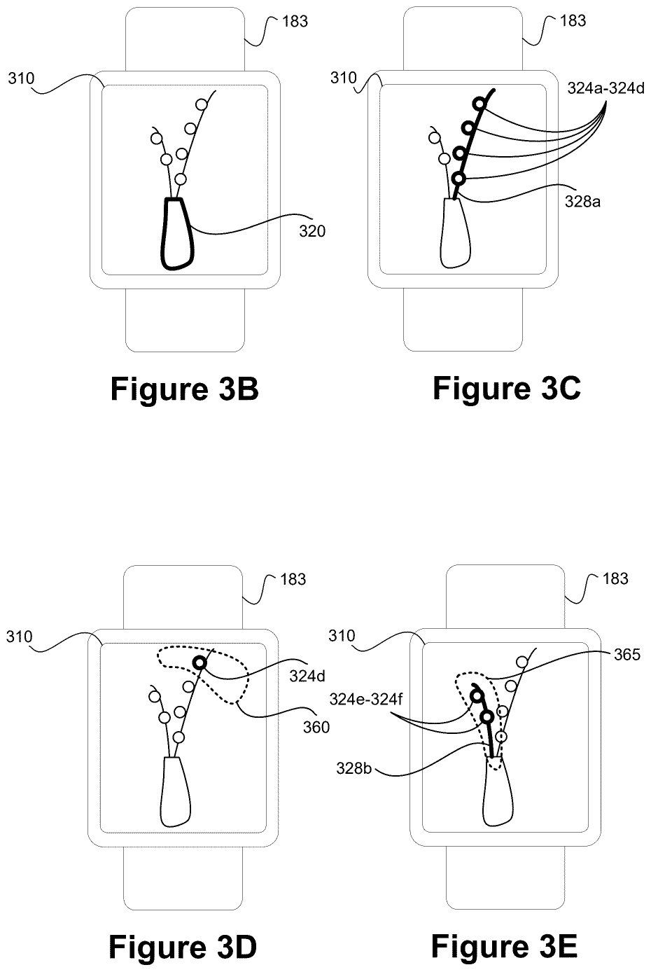

FIGS. 3A-3E illustrate a second wrist disambiguation technique that the user 180 may perform to assist the AI assistant in determining one or more selected segments of the target object which includes the user 180 performing one or more segmentation touch inputs at the wrist-wearable device 183 in response to a segmentation UI 310 presented at the display of the wrist-wearable device 183, in accordance with some embodiments. While FIGS. 3A-3E illustrate the segmentation UI 310 presented at the display of the wrist-wearable device 183 and the user 180 performed the one or more segmentation touch inputs at the wrist-wearable device 183, the second wrist technique may be performed at another device with at least one display (e.g., a smartphone). FIG. 3A illustrates the wrist-wearable device 183 presenting the segmentation UI 310 with the entirety of the target object (e.g., the flower vase 145) selected, in accordance with some embodiments. In some embodiments, the segmentation UI 310 includes a representation of the target object (e.g., a portion of the image data of the field-of-view 100 that includes the target object). The representation of the target object includes a plurality of segments, identified by the AI assistant (and/or any other program or application that identifies object within the field-of-view 100), of the target object (e.g., a vase 320, six flowers 324a-324f, and two flower stems 328a-328b, as illustrated in FIGS. 3A-3E).

The user 180 may select (e.g., by performing a select-all touch input (e.g., a single finger tap) at the display of the wrist-wearable device 183) the entirety of the target object, including all of the plurality of segments, as illustrated in FIG. 3A. In some embodiments, in response to the user 180 selecting the entirety of the target object, each of the plurality of segments appear as highlighted in the segmentation UI 310, as illustrated in FIG. 3A. The user 180 may select (e.g., by performing a select-one-segment touch input (e.g., a double finger tap directed at a single segment of the plurality of segments) at the display of the wrist-wearable device 183) one segment (e.g., the vase 320) of the target object, as illustrated in FIG. 3B. In some embodiments, in response to the user 180 selecting the one segment, the one segment appears as highlighted in the segmentation UI 310, as illustrated in FIG. 3B. The user 180 may select (e.g., by performing one or more select-multiple-segments touch inputs (e.g., a double finger tap directed at multiple segments of the plurality of segments) at the display of the wrist-wearable device 183) two or more segments (e.g., a first flower stem 328a, a first flower 324a, a second flower 324b, a third flower 324c, and a fourth flower 324d) of the target object, as illustrated in FIG. 3C. In some embodiments, in response to the user 180 selecting the two or more segments, the two or more segments appear as highlighted in the segmentation UI 310, as illustrated in FIG. 3C.

In some embodiments, the user 180 may perform a lasso touch input at the display of the wrist-wearable device 183 (and/or the other device with at least one display (e.g., a smartphone)). The lasso touch input comprises the user 180 drawing a circle, box, and/or any other enclosed shape around one or more objects and/or one or more segments of objects at the display of the wrist wearable device. In some embodiments, the select-one-segment touch input performed by the user 180 to select the one segment of the target object is the lasso touch input. For example, as illustrated in FIG. 3D, the user 180 performs a first lasso touch input, tracing a first closed shape 360 around the one segment (e.g., the fourth flower 324d) of the target object to select the one segment. In response to the user 180 performing the first lasso touch input, the one segment appears as highlighted in the segmentation UI 310, as illustrated in FIG. 3D. In some embodiments, the one or more select-multiple-segments touch inputs performed by the user 180 to select the two or more segments of the target object is the lasso touch input. For example, as illustrated in FIG. 3E, the user 180 performs a second lasso touch input, tracing a second closed shape 365 around the two or more segments (e.g., the second flower stem 328b, the fifth flower 324e, and the sixth flower 324f) of the target object to select the two or more segments. In response to the user 180 performing the second lasso touch input, the two or more segments appear as highlighted in the segmentation UI 310, as illustrated in FIG. 3E.

In some embodiments, the representation of the target object (e.g., the portion of the image data of the field-of-view 100 that includes the target object) presented at the display of the wrist-wearable device 183 during the second wrist disambiguation technique is upscaled (e.g., via a machine-learning model) to resolution greater than a resolution of the image data as captured by the one or more cameras of the head-wearable device 188. The upscaling of the representation of the target object may (i) always be performed, (ii) performed in accordance with a determination (e.g., made by the AI assistant) that the resolution of the image data is below a resolution threshold, (iii) performed based on a user setting, and/or (iv) performed in response to an image upscale user input (e.g., an image upscale touch input and/or an image upscale voice command). In some embodiments, the user 180 can perform a zoom-in input (e.g., a pinch-out touch input) to zoom-in the representation of the target object and/or a zoom-out input (e.g., a pinch-in touch input) to zoom-out the representation of the target object. In some embodiments, in response to the user 180 performing the zoom-in input, the representation of the target object is upscaled.

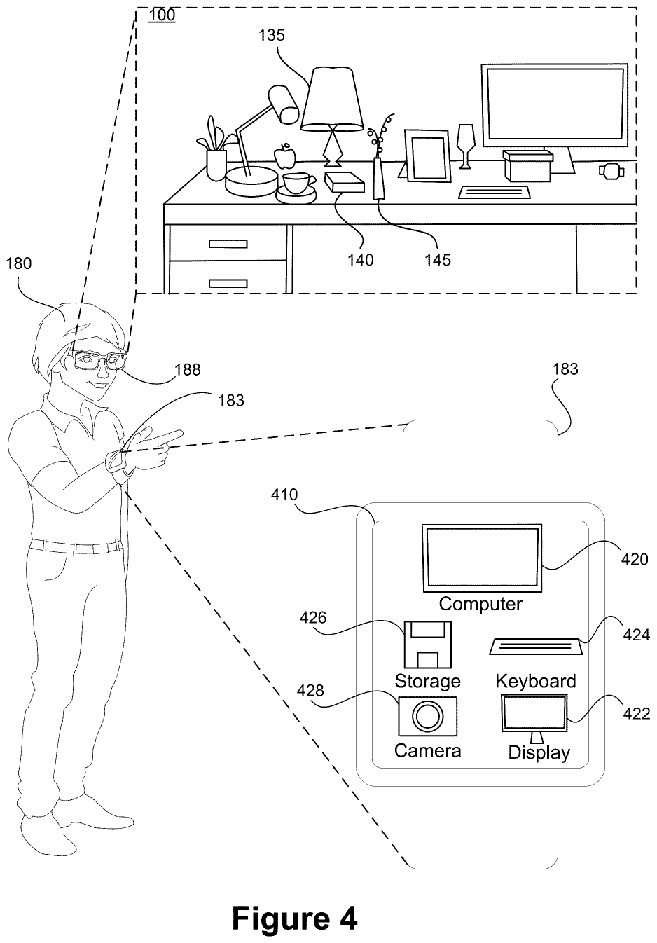

FIG. 4 illustrates a third wrist disambiguation technique that the user 180 may perform to assist the AI assistant in determining one or more selected segments of the target object which includes the user 180 performing one or more other segmentation touch inputs at the wrist-wearable device 183 in response to another segmentation UI 410 presented at the display of the wrist-wearable device 183, in accordance with some embodiments. While FIG. 4 illustrate the other segmentation UI 410 presented at the display of the wrist-wearable device 183 and the user 180 performed the one or more segmentation touch inputs at the wrist-wearable device 183, the third wrist technique may be performed at another device with at least one display (e.g., a smartphone). FIG. 4 illustrates the wrist-wearable device 183 presenting the other segmentation UI 410 where a computer (e.g., including the monitor 165 and the keyboard 160) is the target object, in accordance with some embodiments. The target object includes another plurality of segments, identified by the AI assistant (and/or any other program or application that identifies object within the field-of-view 100). A first portion of the other plurality of segments (e.g., the monitor 165 and the keyboard 160 of the computer) is captured in the image data of the field-of-view 100, and a second portion of the other plurality of segments (e.g., a storage device and a camera of the computer) is not captured in the image data of the field-of-view 100. The AI assistant can determine that the second portion of the other plurality segments are segments of the target object based on the AI assistant's identification of the target object rather than the image data of the field-of-view 100. In some embodiments, the other segmentation UI 410 includes a generated representation of the target object 420 (e.g., generated by one or more generative artificial intelligence models) and a respective generated representation of each of other plurality of segments of the target object (e.g., a generated representation of the display 422, a generated representation of the keyboard 424, a generated representation of the storage device 426, and/or a generated representation of the camera 428, as illustrated in FIG. 4). The user 180 may select the target object and/or one or more of the plurality of other segments by performing another touch input directed at the generated representation of the target object 420 and/or the respective generated representations of each of other plurality of segments.

In some embodiments, one or more selected segments include a plurality of sub-segments (e.g., the keyboard 160 of the computer includes a plurality of keys, a battery, a case, etc.). The user 180 may perform the second wrist disambiguation technique and/or the third wrist disambiguation technique to assist the AI assistant in determining one or more selected sub-segments of the one or more selected segments which includes the user 180 performing one or more additional segmentation touch inputs at the wrist-wearable device 183 in response to an additional segmentation UI presented at the display of the wrist-wearable device 183. In some embodiments, the additional segmentation UI includes respective representations (e.g., respective textual descriptions, respective portions of the image data, and/or respective generated representations) of each of the plurality of sub-segments of the of the one or more selected sub-segments.

The first disambiguation technique, the second disambiguation technique, the third disambiguation technique, the fourth disambiguation technique, the fifth disambiguation technique, the first wrist disambiguation technique, the second wrist disambiguation technique, and/or the third wrist disambiguation technique may be used in combination and/or in succession to enable the user to select one or more selected objects and/or one or more selected segments of the one or more selected objects from the plurality of objects within the field-of-view 100 of the user 180. These techniques may also be used to select one or more selected portions of text (e.g., one or more letters, one or more words, one or more phrases, etc.) from one or more selected pieces of text (e.g., a book, a webpage, handwriting, etc.) of a plurality of pieces of text within the field-of-view 100 of the user 180.

In accordance with the user 180 selecting the one or more selected objects, the one or more selected segments, and/or the one or more selected portions of text, the AI assistant (and/or any other program or application that identifies object within the field-of-view 100) performs one or more tasks associated with the one or more selected objects, the one or more selected segments, and/or the one or more selected portions of text. In some embodiments, the one or more tasks are further based on the query input, one or more context clues, one or more user preferences, and/or one or more intents of the user 180 (e.g., as determined by the AI assistant). For example, if the user 180 selects the book 140, the wrist-wearable device 183 and/or the head-wearable device 188 presents a description of the book 140, while if the user 180 selects the shaded lamp 135, the wrist-wearable device 183 and/or the head-wearable device 188 sends an instruction to the shaded lamp 135 to cause the shaded lamp 135 to turn on. In some embodiments, in response to the user 180 selecting the one or more selected objects, the one or more selected segments, and/or the one or more selected portions of text, the AI assistant causes one or more task suggestions to be presented (e.g., via one or mor visual suggestions (e.g., presented at a display of the wrist-wearable device 183) and/or one or more audio suggestions (e.g., presented at the one or more speakers of the head-wearable device 188)) to the user 180. The user 180 performs a suggestion selection input (e.g., a suggestion selection touch input and/or a suggestion selection voice command) to select the one or more tasks to be performed by the AI assistant from the one or more task suggestions.

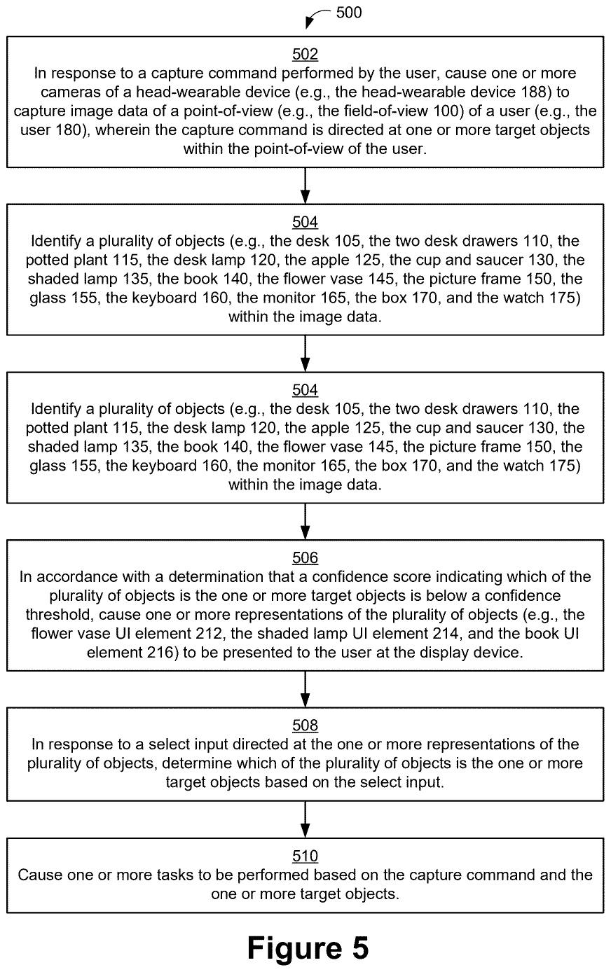

FIG. 5 illustrates a flow diagram of a method of disambiguating objects identified in image data captured at a head-wearable device, in accordance with some embodiments. Operations (e.g., steps) of the method 500 can be performed by one or more processors (e.g., central processing unit and/or MCU) of a system including a head-wearable device, a display device, and one or more processors. At least some of the operations shown in FIG. 5 correspond to instructions stored in a computer memory or computer-readable storage medium (e.g., storage, RAM, and/or memory). Operations of the method 500 can be performed by a single device alone or in conjunction with one or more processors and/or hardware components of another communicatively coupled device (e.g., a wrist-wearable device, a handheld intermediary processing device, a personal computer, etc.) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.
(A1) FIG. 5 shows a flow chart of a method 500 of disambiguating objects identified in image data captured at a head-wearable device, in accordance with some embodiments. The method 500 occurs at a head-wearable device (e.g., the head-wearable device 188) with one or more cameras and a display device (e.g., the other device, such as the wrist-wearable device 183 (e.g., a smart watch), a smartphone, and/or one or more displays of the head-wearable device 188) with one or more displays. The method 500 occurs while the head-wearable device is worn by a user (e.g., the user 180) and the head-wearable device is communicatively coupled to the display device. In some embodiments, the method 500 includes, in response to a capture command (e.g., the query input described in reference to FIGS. 1A-1B) performed by the user, causing one or more cameras of the head-wearable device to capture image data of a point-of-view (e.g., the field-of-view 100) of the user, wherein the capture command is directed at one or more target objects within the point-of-view of the user (502). The method 500 further includes identifying a plurality of objects (e.g., the desk 105, the two desk drawers 110, the potted plant 115, the desk lamp 120, the apple 125, the cup and saucer 130, the shaded lamp 135, the book 140, the flower vase 145, the picture frame 150, the glass 155, the keyboard 160, the monitor 165, the box 170, and the watch 175) within the image data (504). The method 500 further includes, in accordance with a determination that a confidence score indicating which of the plurality of objects is the one or more target objects is below a confidence threshold, causing one or more representations of the plurality of objects (e.g., the flower vase UI element 212, the shaded lamp UI element 214, and the book UI element 216) to be presented to the user at the display device (506). The method 500 further includes, in response to a select input (e.g., the disambiguation touch input, the one or more disambiguation touch inputs, and/or the other touch input, described in reference to FIGS. 2A-2B) directed at the one or more representations of the plurality of objects, determining which of the plurality of objects is the one or more target objects based on the select input (508). The method 500 further includes causing one or more tasks to be performed based on the capture command and the one or more target objects.
(A2) In some embodiments of A2, the method 500 further includes, in accordance with the determination that the confidence score indicating which of the plurality of objects is the one or more target objects is below the confidence threshold, causing a disambiguation indication to be presented to the user, the disambiguation indication (e.g., the disambiguation cue described in reference to FIGS. 1A-1B) indicating that the user must perform the select input.
(A3) In some embodiments of any of A1-A2, the disambiguation indication includes one or more of (i) an audio indication (e.g., the audio message) presented at one or more speakers of the head-wearable device or one or more speakers of the display device, (ii) a haptic indication (e.g., the haptic cue) presented at one or more haptic devices of the head-wearable device or one or more haptic devices of the display device, and (iii) a light-flash indication (e.g., the light cue) presented at one or more lights of the head-wearable device or one or more lights of the display device.
(A4) In some embodiments of any of A1-A3, the capture command is further directed at one or more target segments of a plurality of segments (e.g., the vase 320, the six flowers 324a-324f, and the two flower stems 328a-328b, as described in reference to FIGS. 3A-3E, and/or the display, the keyboard, the storage device, and the camera, as described in reference to FIG. 4) that comprise the one or more target objects within the image data. Additionally, the method 500 further includes identifying the plurality of segments that comprise the one or more target objects. The method 500 further includes, in accordance with the determination of which of the plurality of objects is the one or more target objects and a determination that another confidence score indicating which of the plurality of segments is the one or more target segments is below another confidence threshold, causing one or more representations (e.g., the vase 320, the six flowers 324a-324f, and the two flower stems 328a-328b displayed in the segmentation UI 310, as described in reference to FIGS. 3A-3E, and/or the generated representation of the display 422, the generated representation of the keyboard 424, the generated representation of the storage device 426, and the generated representation of the camera 428 displayed in the other segmentation UI 410, as described in reference to FIG. 4) of the plurality of segments to be presented to the user at the display device. The method 500 further includes, in response to another select input (e.g., the select-all touch input, described in reference to FIG. 3A, the select-one-segment touch input, described in reference to FIG. 3B, the one or more select-multiple-segments touch inputs, described in reference to FIG. 3C, the first lasso touch input, described in reference to FIG. 3D, and/or the second lasso touch input, described in reference to FIG. 3E) directed at the one or more representations of the plurality of segments, determining which of the plurality of segments is the one or more target segments based on the other select input. The method 500 further includes, causing one or more other tasks to be performed based on the capture command and the one or more target segments.
(A5) In some embodiments of any of A1-A6, the plurality of segments that comprise the one or more target objects include (i) a first portion of segments which are visible within the image data (e.g., the vase 320, the six flowers 324a-324f, and the two flower stems 328a-328b displaying the segmentation UI 310, as described in reference to FIGS. 3A-3E, and/or the display and the keyboard, as described in reference to FIG. 4) and (ii) a second portion of segments which are not visible within the image data (e.g., the storage device and the camera, as described in reference to FIG. 4).
(A6) In some embodiments of any of A1-A5, capture command is further directed at one or more target sub-segments of a plurality of sub-segments that comprise the one or more target segments. Additionally, the method 500 further includes identifying the plurality of sub-segments that comprise the one or more target segments. The method 500 further includes, in accordance with the determination of which of the plurality of segments is the one or more target segments and a determination that an additional confidence score indicating which of the plurality of sub-segments is the one or more target sub-segments is below an additional confidence threshold, causing one or more representations of the plurality of sub-segments to be presented to the user at the display device. The method 500 further includes, in response to an additional select input directed at the one or more representations of the plurality of sub-segments, determining which of the plurality of sub-segments is the one or more target sub-segments based on the additional select input. The method 500 further includes causing one or more additional tasks to be performed based on the capture command and the one or more target sub-segments.
(A7) In some embodiments of any of A1-A6, identifying the plurality of objects within the image data, identifying the plurality of segments that comprise the one or more target objects, and identifying the plurality of sub-segments that comprise the one or more target segments are performed by a machine-learning model (e.g., the AI assistant).
(A8) In some embodiments of any of A1-A9, the one or more representations of the plurality of segments includes: (i) one or more segment textual descriptions, each segment textual description of the one or more segment textual descriptions including a description of an associated segment of the plurality of segments, (ii) one or more segment portions of the image data, each segment portion of the one or more segment portions of the image data including image data of an associated segment of the plurality of segments (e.g., the vase 320, the six flowers 324a-324f, and the two flower stems 328a-328b displayed in the segmentation UI 310, as described in reference to FIGS. 3A-3E), and/or (iii) one or more segment generated images, each segment generated image of the one or more segment generated images including a generated image of an associated segment of the plurality of segments (e.g., the generated representation of the display 422, the generated representation of the keyboard 424, the generated representation of the storage device 426, and the generated representation of the camera 428 displayed in the other segmentation UI 410, as described in reference to FIG. 4).
(A9) In some embodiments of any of A1-A8, the one or more representations of the plurality of objects include: (i) one or more textual descriptions, each textual description of the one or more textual descriptions including a description of an associated object of the plurality of objects (e.g., the flower vase UI element 212, the shaded lamp UI element 214, and the book UI element 216 displayed in the displaying the disambiguation UI 210, as described in reference to FIGS. 2A-2B), (ii) one or more portions of the image data, each portion of the one or more portions of the image data including image data of an associated object of the plurality of objects, and (iii) one or more generated images, each generated image of the one or more generated images including a generated image of an associated object of the plurality of objects.
(A10) In some embodiments of any of A1-A9, identifying the plurality of objects within the image data is based on a gaze location (e.g., the gaze location 190) of a gaze of the user in the image data (e.g., captured by a gaze tracking device).
(A11) In some embodiments of any of A1-A10, identifying the plurality of objects within the image data includes assigning a respective probability score (e.g., the one or more probability scores, as described in reference to FIGS. 1A-1B) to each of the plurality of objects within the image data based on at least respective proximity of each of the plurality of objects to the gaze location, wherein each respective probability score is a probability that a respective object is one of the one or more target objects.
(A12) In some embodiments of any of A1-A11, the confidence score is based, at least in part on, the respective probability score associated with each of the plurality of objects.
(A13) In some embodiments of any of A1-A12, the method 500 further includes, in response to a further capture command performed by the user, causing one or more cameras of the head-wearable device to capture image data of a point-of-view of the user, wherein the further capture command is directed at one or more different target objects within the point-of-view of the user and the one or more different target objects are distinct from the one or more target objects. The method 500 further includes, identifying the plurality of objects within the image data. The method 500 further includes, in accordance with a determination that a further confidence score indicating which of the plurality of objects is the one or more different target objects is below the confidence threshold, causing the one or more representations of the plurality of objects to be presented to the user at the display device. The method 500 further includes, in response to a different select input, distinct from the select input, directed at the one or more representations of the plurality of objects, determining which of the plurality of objects is the one or more different target objects based on the different select input. The method 500 further includes, causing one or more further tasks, distinct from the one or more tasks, to be performed based on the further capture command and the one or more different target objects.
(A14) In some embodiments of any of A1-A13, (i) when the one or more target objects are of a first object type, the one or more tasks correspond to a first operation and (ii) when the one or more target objects are of a second object type, the one or more tasks correspond to a second operation, distinct from the first operation.
(A15) In some embodiments of any of A1-A14, the method 500 further includes in response to a third capture command performed by the user, causing one or more cameras of the head-wearable device to capture third image data of the point-of-view of the user, wherein the third capture command is directed at one or more third target objects within the point-of-view of the user. The method 500 further includes identifying a plurality of third objects (e.g., the flower vase 145, the shaded lamp 135, and the book 140, as described in reference to FIG. 2A) within the third image data. The method 500 further includes, in accordance with a determination that a third confidence score indicating which of the plurality of third objects is the one or more third target objects is below the confidence threshold, causing one or more representations (e.g., the flower vase UI element 212, the shaded lamp UI element 214, and the book UI element 216, as illustrated in FIG. 2A) of the plurality of third objects to be presented to the user at the display device. The method 500 further includes, in response to detecting that the user has moved closer to the one or more target objects (e.g., as described in reference to FIGS. 2A-2B), causing the one or more cameras of the head-wearable device to capture fourth image data of a fourth point-of-view (e.g., the field-of-view 100, as illustrated in FIG. 2B) of the user. The method 500 further includes identifying a plurality of fourth objects (e.g., the flower vase 145 and the book 140, as described in reference to FIG. 2B) within the image data. The method 500 further includes, in accordance with a determination that a fourth confidence score indicating which of the plurality of fourth objects is the one or more target objects is below the confidence threshold, causing one or more representations (e.g., the flower vase UI element 212 and the book UI element 216, as illustrated in FIG. 2B) of the plurality of fourth objects to be presented to the user at the display device. The method 500 further includes, in response to a third select input directed at the one or more representations of the plurality of fourth objects, determining which of the plurality of fourth objects is the one or more third target objects based on the third select input. The method 500 further includes causing one or more third tasks to be performed based on the third capture command and the one or more third target objects.
(A16) In some embodiments of any of A1-A15, the method 500 further includes, after causing the one or more tasks to be performed, causing information to be presented to the user at one or more of the head-wearable device and the display device, wherein the information is based on the one or more tasks (e.g., if the user 180 selects the book 140, the wrist-wearable device 183 and/or the head-wearable device 188 presents a description of the book 140).
(A17) In some embodiments of any of A1-A16, the display device includes a touchscreen (e.g., a display that can display visual information and detect touch inputs). The select input directed at the one or more representations of the plurality of objects includes one or more of (i) one or more touch inputs directed at the one or more representations of the plurality of objects and (e.g., the select-all touch input, described in reference to FIG. 3A, the select-one-segment touch input, described in reference to FIG. 3B, and/or the one or more select-multiple-segments touch inputs, described in reference to FIG. 3C) (ii) a lasso touch input encompassing the one or more representations of the plurality of objects (e.g., the first lasso touch input, described in reference to FIG. 3D, and/or the second lasso touch input, described in reference to FIG. 3E).
(A18) In some embodiments of any of A1-A17, the capture command is one or more of (i) a voice command (e.g., the query voice command), wherein the voice command identifies the one or more target objects, (ii) a hand gesture (e.g., the query hand gesture), and/or (iii) a button press (e.g., the query button press).
(A19) In some embodiments of any of A1-A18, the head-wearable device is a pair of smart glasses (e.g., as illustrated in FIG. 1A) and the display device is one or more of a smart watch (e.g., as illustrated in FIG. 1A), one or more displays of the head-wearable device, and a smartphone.
(B1) In accordance with some embodiments, a system that includes a display device (e.g., the wrist-wearable device 183 (e.g., a smart watch), a smartphone, and/or one or more displays of the head-wearable device 188) and a head-wearable device (e.g., the head-wearable device 188), the system is configured to perform operations corresponding to any of A1-A19.
(C1) In accordance with some embodiments, a non-transitory computer readable storage medium including instructions that, when executed by a processing device in communication with a head-wearable device (e.g., the head-wearable device 188) and a display device (e.g., the wrist-wearable device 183 (e.g., a smart watch), a smartphone, and/or one or more displays of the head-wearable device 188), cause the processing device to perform operations corresponding to any of A1-A19.
(D1) In accordance with some embodiments, a display device (e.g., the wrist-wearable device 183 (e.g., a smart watch), a smartphone, and/or one or more displays of the head-wearable device 188) communicatively coupled to a head-wearable device (e.g., the head-wearable device 188), the display device configured to perform operations corresponding to any of A1-A19.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

### Example Extended-Reality Systems

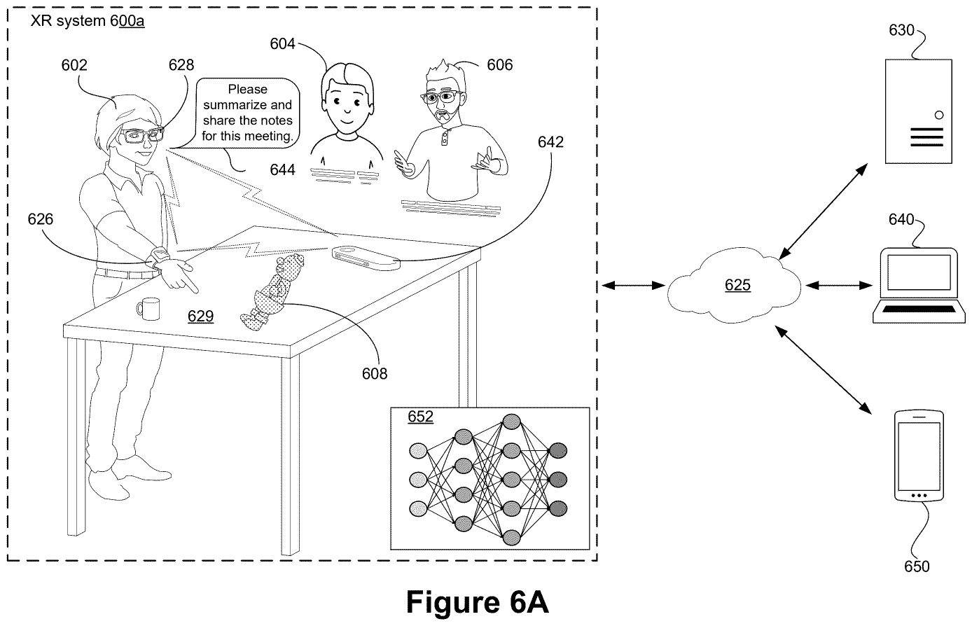

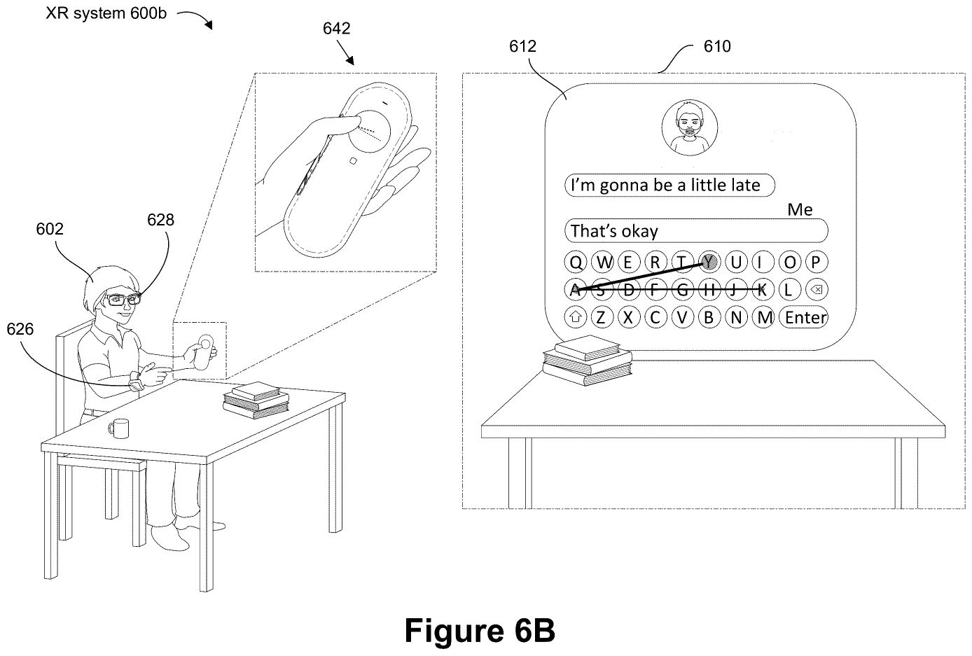

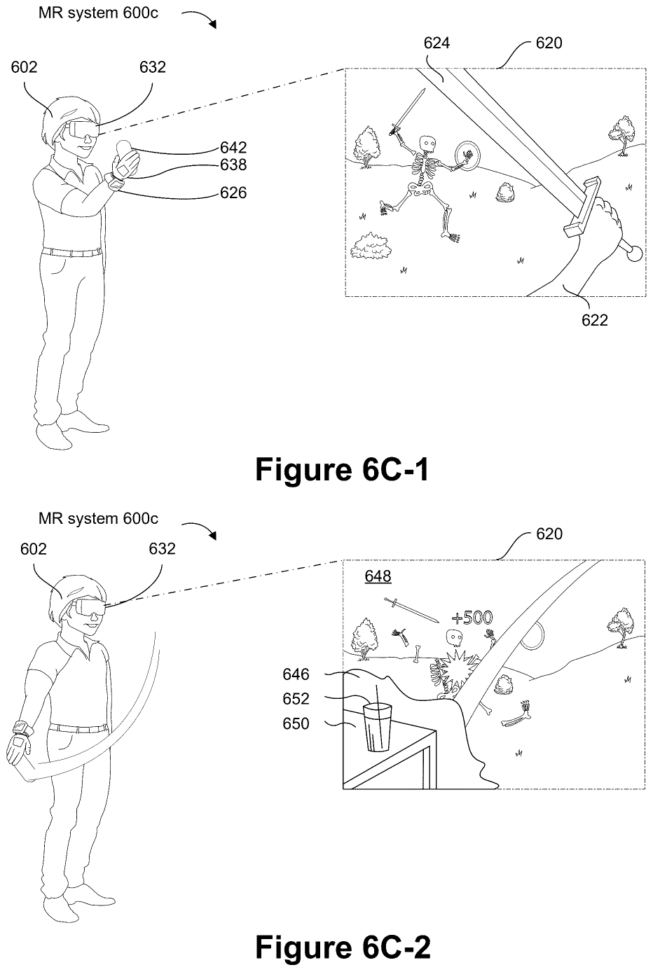

FIGS. 6A 6B, 6C-1, and 6C-2, illustrate example XR systems that include AR and MR systems, in accordance with some embodiments. FIG. 6A shows a first XR system 600a and first example user interactions using a wrist-wearable device 626, a head-wearable device (e.g., AR device 628), and/or a HIPD 642. FIG. 6B shows a second XR system 600b and second example user interactions using a wrist-wearable device 626, AR device 628, and/or an HIPD 642. FIGS. 6C-1 and 6C-2 show a third MR system 600c and third example user interactions using a wrist-wearable device 626, a head-wearable device (e.g., an MR device such as a VR device), and/or an HIPD 642. As the skilled artisan will appreciate upon reading the descriptions provided herein, the above-example AR and MR systems (described in detail below) can perform various functions and/or operations.

The wrist-wearable device 626, the head-wearable devices, and/or the HIPD 642 can communicatively couple via a network 625 (e.g., cellular, near field, Wi-Fi, personal area network, wireless LAN). Additionally, the wrist-wearable device 626, the head-wearable device, and/or the HIPD 642 can also communicatively couple with one or more servers 630, computers 640 (e.g., laptops, computers), mobile devices 650 (e.g., smartphones, tablets), and/or other electronic devices via the network 625 (e.g., cellular, near field, Wi-Fi, personal area network, wireless LAN). Similarly, a smart textile-based garment, when used, can also communicatively couple with the wrist-wearable device 626, the head-wearable device(s), the HIPD 642, the one or more servers 630, the computers 640, the mobile devices 650, and/or other electronic devices via the network 625 to provide inputs.

Turning to FIG. 6A, a user 602 is shown wearing the wrist-wearable device 626 and the AR device 628 and having the HIPD 642 on their desk. The wrist-wearable device 626, the AR device 628, and the HIPD 642 facilitate user interaction with an AR environment. In particular, as shown by the first AR system 600a, the wrist-wearable device 626, the AR device 628, and/or the HIPD 642 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 626, the AR device 628, and/or the HIPD 642. In addition, the user 602 is also able to directly view physical objects in the environment, such as a physical table 629, through transparent lens(es) and waveguide(s) of the AR device 628. Alternatively, an MR device could be used in place of the AR device 628 and a similar user experience can take place, but the user would not be directly viewing physical objects in the environment, such as table 629, and would instead be presented with a virtual reconstruction of the table 629 produced from one or more sensors of the MR device (e.g., an outward facing camera capable of recording the surrounding environment).

The user 602 can use any of the wrist-wearable device 626, the AR device 628 (e.g., through physical inputs at the AR device and/or built-in motion tracking of a user's extremities), a smart-textile garment, externally mounted extremity tracking device, the HIPD 642 to provide user inputs, etc. For example, the user 602 can perform one or more hand gestures that are detected by the wrist-wearable device 626 (e.g., using one or more EMG sensors and/or IMUs built into the wrist-wearable device) and/or AR device 628 (e.g., using one or more image sensors or cameras) to provide a user input. Alternatively, or additionally, the user 602 can provide a user input via one or more touch surfaces of the wrist-wearable device 626, the AR device 628, and/or the HIPD 642, and/or voice commands captured by a microphone of the wrist-wearable device 626, the AR device 628, and/or the HIPD 642. The wrist-wearable device 626, the AR device 628, and/or the HIPD 642 include an artificially intelligent digital assistant to help the user in providing a user input (e.g., completing a sequence of operations, suggesting different operations or commands, providing reminders, confirming a command). For example, the digital assistant can be invoked through an input occurring at the AR device 628 (e.g., via an input at a temple arm of the AR device 628). In some embodiments, the user 602 can provide a user input via one or more facial gestures and/or facial expressions. For example, cameras of the wrist-wearable device 626, the AR device 628, and/or the HIPD 642 can track the user 602's eyes for navigating a user interface.

The wrist-wearable device 626, the AR device 628, and/or the HIPD 642 can operate alone or in conjunction to allow the user 602 to interact with the AR environment. In some embodiments, the HIPD 642 is configured to operate as a central hub or control center for the wrist-wearable device 626, the AR device 628, and/or another communicatively coupled device. For example, the user 602 can provide an input to interact with the AR environment at any of the wrist-wearable device 626, the AR device 628, and/or the HIPD 642, and the HIPD 642 can identify one or more back-end and front-end tasks to cause the performance of the requested interaction and distribute instructions to cause the performance of the one or more back-end and front-end tasks at the wrist-wearable device 626, the AR device 628, and/or the HIPD 642. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 642 can perform the back-end tasks and provide the wrist-wearable device 626 and/or the AR device 628 operational data corresponding to the performed back-end tasks such that the wrist-wearable device 626 and/or the AR device 628 can perform the front-end tasks. In this way, the HIPD 642, which has more computational resources and greater thermal headroom than the wrist-wearable device 626 and/or the AR device 628, performs computationally intensive tasks and reduces the computer resource utilization and/or power usage of the wrist-wearable device 626 and/or the AR device 628.

In the example shown by the first AR system 600a, the HIPD 642 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 642 performs back-end tasks for processing and/or rendering image data (and other data) associated with the AR video call and provides operational data associated with the performed back-end tasks to the AR device 628 such that the AR device 628 performs front-end tasks for presenting the AR video call (e.g., presenting the avatar 604 and the digital representation of the contact 606).

In some embodiments, the HIPD 642 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 642. In particular, the HIPD 642 and the AR device 628 operate in conjunction to determine a location for presenting the avatar 604 and the digital representation of the contact 606. In some embodiments, information can be presented within a predetermined distance from the HIPD 642 (e.g., within five meters). For example, as shown in the first AR system 600a, virtual object 608 is presented on the desk some distance from the HIPD 642. Similar to the above example, the HIPD 642 and the AR device 628 can operate in conjunction to determine a location for presenting the virtual object 608. Alternatively, in some embodiments, presentation of information is not bound by the HIPD 642. More specifically, the avatar 604, the digital representation of the contact 606, and the virtual object 608 do not have to be presented within a predetermined distance of the HIPD 642. While an AR device 628 is described working with an HIPD, an MR headset can be interacted with in the same way as the AR device 628.

User inputs provided at the wrist-wearable device 626, the AR device 628, and/or the HIPD 642 are coordinated such that the user can use any device to initiate, continue, and/or complete an operation. For example, the user 602 can provide a user input to the AR device 628 to cause the AR device 628 to present the virtual object 608 and, while the virtual object 608 is presented by the AR device 628, the user 602 can provide one or more hand gestures via the wrist-wearable device 626 to interact and/or manipulate the virtual object 608. While an AR device 628 is described working with a wrist-wearable device 626, an MR headset can be interacted with in the same way as the AR device 628.

Integration of Artificial Intelligence with XR Systems

FIG. 6A illustrates an interaction in which an artificially intelligent virtual assistant can assist in requests made by a user 602. The AI virtual assistant can be used to complete open-ended requests made through natural language inputs by a user 602. For example, in FIG. 6A the user 602 makes an audible request 644 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 6A also illustrates an example neural network 652 used in Artificial Intelligence applications. Uses of Artificial Intelligence (AI) are varied and encompass many different aspects of the devices and systems described herein. AI capabilities cover a diverse range of applications and deepen interactions between the user 602 and user devices (e.g., the AR device 628, an MR device 632, the HIPD 642, the wrist-wearable device 626). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 602 can interact with an AI model through natural language inputs captured by a voice sensor, text inputs, or any other input modality that accepts natural language and/or a corresponding voice sensor module. In another instance, input is provided by tracking the eye gaze of a user 602 via a gaze tracker module. Additionally, the AI model can also receive inputs beyond those supplied by a user 602. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors'data can be retrieved entirely from a single device (e.g., AR device 628) or from multiple devices that are in communication with each other (e.g., a system that includes at least two of an AR device 628, an MR device 632, the HIPD 642, the wrist-wearable device 626, etc.). The AI model can also access additional information (e.g., one or more servers 630, the computers 640, the mobile devices 650, and/or other electronic devices) via a network 625.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 628, an MR device 632, the HIPD 642, the wrist-wearable device 626) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 628, an MR device 632, the HIPD 642, the wrist-wearable device 626), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 642), haptic feedback can provide information to the user 602. An AI model can also use the inputs described above to determine the appropriate modality and device(s) to present content to the user (e.g., a user walking on a busy road can be presented with an audio output instead of a visual output to avoid distracting the user 602).

### Example Augmented Reality Interaction

FIG. 6B shows the user 602 wearing the wrist-wearable device 626 and the AR device 628 and holding the HIPD 642. In the second AR system 600b, the wrist-wearable device 626, the AR device 628, and/or the HIPD 642 are used to receive and/or provide one or more messages to a contact of the user 602. In particular, the wrist-wearable device 626, the AR device 628, and/or the HIPD 642 detect and coordinate one or more user inputs to initiate a messaging application and prepare a response to a received message via the messaging application.

In some embodiments, the user 602 initiates, via a user input, an application on the wrist-wearable device 626, the AR device 628, and/or the HIPD 642 that causes the application to initiate on at least one device. For example, in the second AR system 600b the user 602 performs a hand gesture associated with a command for initiating a messaging application (represented by messaging user interface 612); the wrist-wearable device 626 detects the hand gesture; and, based on a determination that the user 602 is wearing the AR device 628, causes the AR device 628 to present a messaging user interface 612 of the messaging application. The AR device 628 can present the messaging user interface 612 to the user 602 via its display (e.g., as shown by user 602's field of view 610). In some embodiments, the application is initiated and can be run on the device (e.g., the wrist-wearable device 626, the AR device 628, and/or the HIPD 642) that detects the user input to initiate the application, and the device provides another device operational data to cause the presentation of the messaging application. For example, the wrist-wearable device 626 can detect the user input to initiate a messaging application, initiate and run the messaging application, and provide operational data to the AR device 628 and/or the HIPD 642 to cause presentation of the messaging application. Alternatively, the application can be initiated and run at a device other than the device that detected the user input. For example, the wrist-wearable device 626 can detect the hand gesture associated with initiating the messaging application and cause the HIPD 642 to run the messaging application and coordinate the presentation of the messaging application.

Further, the user 602 can provide a user input provided at the wrist-wearable device 626, the AR device 628, and/or the HIPD 642 to continue and/or complete an operation initiated at another device. For example, after initiating the messaging application via the wrist-wearable device 626 and while the AR device 628 presents the messaging user interface 612, the user 602 can provide an input at the HIPD 642 to prepare a response (e.g., shown by the swipe gesture performed on the HIPD 642). The user 602's gestures performed on the HIPD 642 can be provided and/or displayed on another device. For example, the user 602's swipe gestures performed on the HIPD 642 are displayed on a virtual keyboard of the messaging user interface 612 displayed by the AR device 628.

In some embodiments, the wrist-wearable device 626, the AR device 628, the HIPD 642, and/or other communicatively coupled devices can present one or more notifications to the user 602. The notification can be an indication of a new message, an incoming call, an application update, a status update, etc. The user 602 can select the notification via the wrist-wearable device 626, the AR device 628, or the HIPD 642 and cause presentation of an application or operation associated with the notification on at least one device. For example, the user 602 can receive a notification that a message was received at the wrist-wearable device 626, the AR device 628, the HIPD 642, and/or other communicatively coupled device and provide a user input at the wrist-wearable device 626, the AR device 628, and/or the HIPD 642 to review the notification, and the device detecting the user input can cause an application associated with the notification to be initiated and/or presented at the wrist-wearable device 626, the AR device 628, and/or the HIPD 642.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 628 can present to the user 602 game application data and the HIPD 642 can use a controller to provide inputs to the game. Similarly, the user 602 can use the wrist-wearable device 626 to initiate a camera of the AR device 628, and the user can use the wrist-wearable device 626, the AR device 628, and/or the HIPD 642 to manipulate the image capture (e.g., zoom in or out, apply filters) and capture image data.

While an AR device 628 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 6C-1 and 6C-2, the user 602 is shown wearing the wrist-wearable device 626 and an MR device 632 (e.g., a device capable of providing either an entirely VR experience or an MR experience that displays object(s) from a physical environment at a display of the device) and holding the HIPD 642. In the third AR system 600c, the wrist-wearable device 626, the MR device 632, and/or the HIPD 642 are used to interact within an MR environment, such as a VR game or other MR/VR application. While the MR device 632 presents a representation of a VR game (e.g., first MR game environment 620) to the user 602, the wrist-wearable device 626, the MR device 632, and/or the HIPD 642 detect and coordinate one or more user inputs to allow the user 602 to interact with the VR game.

In some embodiments, the user 602 can provide a user input via the wrist-wearable device 626, the MR device 632, and/or the HIPD 642 that causes an action in a corresponding MR environment. For example, the user 602 in the third MR system 600c (shown in FIG. 6C-1) raises the HIPD 642 to prepare for a swing in the first MR game environment 620. The MR device 632, responsive to the user 602 raising the HIPD 642, causes the MR representation of the user 622 to perform a similar action (e.g., raise a virtual object, such as a virtual sword 624). In some embodiments, each device uses respective sensor data and/or image data to detect the user input and provide an accurate representation of the user 602's motion. For example, image sensors (e.g., SLAM cameras or other cameras) of the HIPD 642 can be used to detect a position of the HIPD 642 relative to the user 602's body such that the virtual object can be positioned appropriately within the first MR game environment 620; sensor data from the wrist-wearable device 626 can be used to detect a velocity at which the user 602 raises the HIPD 642 such that the MR representation of the user 622 and the virtual sword 624 are synchronized with the user 602's movements; and image sensors of the MR device 632 can be used to represent the user 602's body, boundary conditions, or real-world objects within the first MR game environment 620.

In FIG. 6C-2, the user 602 performs a downward swing while holding the HIPD 642. The user 602's downward swing is detected by the wrist-wearable device 626, the MR device 632, and/or the HIPD 642 and a corresponding action is performed in the first MR game environment 620. In some embodiments, the data captured by each device is used to improve the user's experience within the MR environment. For example, sensor data of the wrist-wearable device 626 can be used to determine a speed and/or force at which the downward swing is performed and image sensors of the HIPD 642 and/or the MR device 632 can be used to determine a location of the swing and how it should be represented in the first MR game environment 620, which, in turn, can be used as inputs for the MR environment (e.g., game mechanics, which can use detected speed, force, locations, and/or aspects of the user 602's actions to classify a user's inputs (e.g., user performs a light strike, hard strike, critical strike, glancing strike, miss) or calculate an output (e.g., amount of damage)).

FIG. 6C-2 further illustrates that a portion of the physical environment is reconstructed and displayed at a display of the MR device 632 while the MR game environment 620 is being displayed. In this instance, a reconstruction of the physical environment 646 is displayed in place of a portion of the MR game environment 620 when object(s) in the physical environment are potentially in the path of the user (e.g., a collision with the user and an object in the physical environment are likely). Thus, this example MR game environment 620 includes (i) an immersive VR portion 648 (e.g., an environment that does not have a corollary counterpart in a nearby physical environment) and (ii) a reconstruction of the physical environment 646 (e.g., table 650 and cup 652). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 626, the MR device 632, and/or the HIPD 642 are described as detecting user inputs, in some embodiments, user inputs are detected at a single device (with the single device being responsible for distributing signals to the other devices for performing the user input). For example, the HIPD 642 can operate an application for generating the first MR game environment 620 and provide the MR device 632 with corresponding data for causing the presentation of the first MR game environment 620, as well as detect the user 602's movements (while holding the HIPD 642) to cause the performance of corresponding actions within the first MR game environment 620. Additionally or alternatively, in some embodiments, operational data (e.g., sensor data, image data, application data, device data, and/or other data) of one or more devices is provided to a single device (e.g., the HIPD 642) to process the operational data and cause respective devices to perform an action associated with processed operational data.

In some embodiments, the user 602 can wear a wrist-wearable device 626, wear an MR device 632, wear smart textile-based garments 638 (e.g., wearable haptic gloves), and/or hold an HIPD 642 device. In this embodiment, the wrist-wearable device 626, the MR device 632, and/or the smart textile-based garments 638 are used to interact within an MR environment (e.g., any AR or MR system described above in reference to FIGS. 6A-6B). While the MR device 632 presents a representation of an MR game (e.g., second MR game environment 620) to the user 602, the wrist-wearable device 626, the MR device 632, and/or the smart textile-based garments 638 detect and coordinate one or more user inputs to allow the user 602 to interact with the MR environment.

In some embodiments, the user 602 can provide a user input via the wrist-wearable device 626, an HIPD 642, the MR device 632, and/or the smart textile-based garments 638 that causes an action in a corresponding MR environment. In some embodiments, each device uses respective sensor data and/or image data to detect the user input and provide an accurate representation of the user 602's motion. While four different input devices are shown (e.g., a wrist-wearable device 626, an MR device 632, an HIPD 642, and a smart textile-based garment 638) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 638) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 638 can be used in conjunction with an MR device and/or an HIPD 642.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 6A-6C-2 provided above are intended to augment the description provided in reference to FIGS. 1A-5. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory, computer-readable storage medium including executable instructions that, when executed by one or more processors, cause the one or more processors to:
while a head-wearable device is worn by a user and the head-wearable device is communicatively coupled to a display device:
in response to a capture command performed by the user, cause one or more cameras of the head-wearable device to capture image data of a point-of-view of the user, wherein the capture command is directed at one or more target objects within the point-of-view of the user;
identify a plurality of objects within the image data;
in accordance with a determination that a confidence score indicating which of the plurality of objects is the one or more target objects is below a confidence threshold, cause one or more representations of the plurality of objects to be presented to the user at the display device;
in response to a select input directed at the one or more representations of the plurality of objects, determine which of the plurality of objects is the one or more target objects based on the select input; and
cause one or more tasks to be performed based on the capture command and the one or more target objects.

2. The non-transitory, computer-readable storage medium of claim 1, wherein the executable instructions further cause the one or more processors to:
in accordance with the determination that the confidence score indicating which of the plurality of objects is the one or more target objects is below the confidence threshold, cause a disambiguation indication to be presented to the user, the disambiguation indication indicating that the user must perform the select input.

3. The non-transitory, computer-readable storage medium of claim 2, wherein the disambiguation indication includes one or more of:
an audio indication presented at one or more speakers of the head-wearable device or one or more speakers of the display device;
a haptic indication presented at one or more haptic devices of the head-wearable device or one or more haptic devices of the display device; and
a light-flash indication presented at one or more lights of the head-wearable device or one or more lights of the display device.

4. The non-transitory, computer-readable storage medium of claim 1, wherein the capture command is further directed at one or more target segments of a plurality of segments that comprise the one or more target objects within the image data, and the executable instructions further cause the one or more processors to:
identify the plurality of segments that comprise the one or more target objects;
in accordance with the determination of which of the plurality of objects is the one or more target objects and a determination that another confidence score indicating which of the plurality of segments is the one or more target segments is below another confidence threshold, cause one or more representations of the plurality of segments to be presented to the user at the display device;
in response to another select input directed at the one or more representations of the plurality of segments, determine which of the plurality of segments is the one or more target segments based on the other select input; and
cause one or more other tasks to be performed based on the capture command and the one or more target segments.

5. The non-transitory, computer-readable storage medium of claim 4, wherein the plurality of segments that comprise the one or more target objects include:
a first portion of segments which are visible within the image data; and
a second portion of segments which are not visible within the image data.

6. The non-transitory, computer-readable storage medium of claim 4, wherein the capture command is further directed at one or more target sub-segments of a plurality of sub-segments that comprise the one or more target segments, and the executable instructions further cause the one or more processors to:
identify the plurality of sub-segments that comprise the one or more target segments;
in accordance with the determination of which of the plurality of segments is the one or more target segments and a determination that an additional confidence score indicating which of the plurality of sub-segments is the one or more target sub-segments is below an additional confidence threshold, cause one or more representations of the plurality of sub-segments to be presented to the user at the display device;
in response to an additional select input directed at the one or more representations of the plurality of sub-segments, determine which of the plurality of sub-segments is the one or more target sub-segments based on the additional select input; and
cause one or more additional tasks to be performed based on the capture command and the one or more target sub-segments.

7. The non-transitory, computer-readable storage medium of claim 6, wherein identifying the plurality of objects within the image data, identifying the plurality of segments that comprise the one or more target objects, and identifying the plurality of sub-segments that comprise the one or more target segments are performed by a machine-learning model.

8. The non-transitory, computer-readable storage medium of claim 4, wherein the one or more representations of the plurality of segments includes:
one or more segment textual descriptions, each segment textual description of the one or more segment textual descriptions including a description of an associated segment of the plurality of segments;
one or more segment portions of the image data, each segment portion of the one or more segment portions of the image data including image data of an associated segment of the plurality of segments; and
one or more segment generated images, each segment generated image of the one or more segment generated images including a generated image of an associated segment of the plurality of segments.

9. The non-transitory, computer-readable storage medium of claim 1, wherein the one or more representations of the plurality of objects includes:
one or more textual descriptions, each textual description of the one or more textual descriptions including a description of an associated object of the plurality of objects;
one or more portions of the image data, each portion of the one or more portions of the image data including image data of an associated object of the plurality of objects; and
one or more generated images, each generated image of the one or more generated images including a generated image of an associated object of the plurality of objects.

10. The non-transitory, computer-readable storage medium of claim 1, wherein identifying the plurality of objects within the image data is based on a gaze location of a gaze of the user in the image data.

11. The non-transitory, computer-readable storage medium of claim 10, wherein identifying the plurality of objects within the image data includes assigning a respective probability score to each of the plurality of objects within the image data based on at least respective proximity of each of the plurality of objects to the gaze location, wherein each respective probability score is a probability that a respective object is one of the one or more target objects.

12. The non-transitory, computer-readable storage medium of claim 1, wherein the executable instructions further cause the one or more processors to:
while the head-wearable device is worn by the user and the head-wearable device is communicatively coupled to the display device:
in response to a further capture command performed by the user, cause one or more cameras of the head-wearable device to capture image data of a point-of-view of the user, wherein the further capture command is directed at one or more different target objects within the point-of-view of the user and the one or more different target objects are distinct from the one or more target objects;
identify the plurality of objects within the image data;
in accordance with a determination that a further confidence score indicating which of the plurality of objects is the one or more different target objects is below the confidence threshold, cause the one or more representations of the plurality of objects to be presented to the user at the display device;
in response to a different select input, distinct from the select input, directed at the one or more representations of the plurality of objects, determine which of the plurality of objects is the one or more different target objects based on the different select input; and
cause one or more further tasks, distinct from the one or more tasks, to be performed based on the further capture command and the one or more different target objects.

13. The non-transitory, computer-readable storage medium of claim 1, wherein:
when the one or more target objects are of a first object type, the one or more tasks correspond to a first operation; and
when the one or more target objects are of a second object type, the one or more tasks correspond to a second operation, distinct from the first operation.

14. The non-transitory, computer-readable storage medium of claim 1, wherein the executable instructions further cause the one or more processors to:
while the head-wearable device is worn by the user and the head-wearable device is communicatively coupled to the display device:
in response to a third capture command performed by the user, cause one or more cameras of the head-wearable device to capture third image data of the point-of-view of the user, wherein the third capture command is directed at one or more third target objects within the point-of-view of the user;
identify a plurality of third objects within the third image data;
in accordance with a determination that a third confidence score indicating which of the plurality of third objects is the one or more third target objects is below the confidence threshold, cause one or more representations of the plurality of third objects to be presented to the user at the display device;
in response to detecting that the user has moved closer to the one or more target objects, cause the one or more cameras of the head-wearable device to capture fourth image data of a fourth point-of-view of the user;
identify a plurality of fourth objects within the image data;
in accordance with a determination that a fourth confidence score indicating which of the plurality of fourth objects is the one or more target objects is below the confidence threshold, cause one or more representations of the plurality of fourth objects to be presented to the user at the display device;
in response to a third select input directed at the one or more representations of the plurality of fourth objects, determine which of the plurality of fourth objects is the one or more third target objects based on the third select input; and
cause one or more third tasks to be performed based on the third capture command and the one or more third target objects.

15. The non-transitory, computer-readable storage medium of claim 1, wherein the executable instructions further cause the one or more processors to:
after causing the one or more tasks to be performed, cause information to be presented to the user at one or more of the head-wearable device and the display device, wherein the information is based on the one or more tasks.

16. The non-transitory, computer-readable storage medium of claim 1, wherein the display device includes a touchscreen, and the select input directed at the one or more representations of the plurality of objects includes one or more of:
one or more touch inputs directed at the one or more representations of the plurality of objects; and
a lasso touch input encompassing the one or more representations of the plurality of objects.

17. The non-transitory, computer-readable storage medium of claim 1, wherein the capture command is one or more of:
a voice command, wherein the voice command identifies the one or more target objects;
a hand gesture; and
a button press.

18. The non-transitory, computer-readable storage medium of claim 1, wherein:
the head-wearable device is a pair of smart glasses; and
the display device is one or more of a smart watch, one or more displays of the head-wearable device, and a smartphone.

19. A system including:
a head-wearable device including one or more cameras;
a display device including a display, wherein the display device is communicatively coupled to the head-wearable device;
one or more processors, wherein the one or more processors are communicatively coupled to the head-wearable device and the display device; and
a storage device including executable instructions that, when executed by one or more processors, cause the one or more processors to, while the head-wearable device is worn by a user:
in response to a capture command performed by the user, cause the one or more cameras of the head-wearable device to capture image data of a point-of-view of the user, wherein the capture command is directed at one or more target objects within the point-of-view of the user;
identify a plurality of objects within the image data;
in accordance with a determination that a confidence score indicating which of the plurality of objects is the one or more target objects is below a confidence threshold, cause one or more representations of the plurality of objects to be presented to the user at the display device;
in response to a select input directed at the one or more representations of the plurality of objects, determine which of the plurality of objects is the one or more target objects based on the select input; and
cause one or more tasks to be performed based on the capture command and the one or more target objects.

20. A method comprising:
while a head-wearable device is worn by a user and the head-wearable device is communicatively coupled to a display device:
in response to a capture command performed by the user, capturing image data of a point-of-view of the user at one or more cameras of the head-wearable device, wherein the capture command is directed at one or more target objects within the point-of-view of the user;
identifying a plurality of objects within the image data;
in accordance with a determination that a confidence score indicating which of the plurality of objects is the one or more target objects is below a confidence threshold, presenting one or more representations of the plurality of objects to the user at the display device;
in response to a select input directed at the one or more representations of the plurality of objects, determining which of the plurality of objects is the one or more target objects based on the select input; and
performing one or more tasks based on the capture command and the one or more target objects.
